(19) United States
(12) Patent Application Publication
(10) Pub. No.: US 2014/0138319 A1
(43) Pub. Date: May 22, 2014

(54) Dental Amalgam Filter Including Tungsten Disulfide Nanopowder

(71) Applicant: Patty Fu-Giles, University Park, IL (US)

(72) Inventor: Patty Fu-Giles, University Park, IL (US)

(21) Appl. No.: 13/683,196

(22) Filed: Nov. 21, 2012

(51) Int. Cl. C02F 1/28

(52) U.S. Cl. CPC C02F 1/281; C02F 1/288
USPC 210/670; 210/490; 210/660

(57) ABSTRACT

The present invention relates to the preparation and use of a three-dimensional polymer matrix including tungsten disulfide nanopowder coated on and embedded within a solid porous support for removing water soluble and micro-particulate mercury species from waste water including dental effluent. The solid porous support can be regenerated upon washing with an appropriate chelating ligand for reuse.

### TECHNICAL FIELD

The present invention relates in general to removing mercury from waste water and, in particular, to removing water soluble and micro-particulate mercury species from dental effluent.

### BACKGROUND OF THE INVENTION

The operators of coal-fired power plants have received substantial criticism over the years for mercury (Hg) emissions and the resulting contamination of aquatic systems. However, according to the Mercury Policy Project (MPP), the dental industry is also a significant contributor to aquatic mercury contamination. The shavings from new amalgam fillings and from the removal of old fillings make American dentistry one of the largest sources of mercury pollution in waste water. A dental amalgam is a blend of mercury and other metals or alloys including silver, tin, copper and zinc. Modern low-copper amalgams (3.6% copper) comprise about 42-45 percent mercury by weight. Mercury amalgams are still commonly used in dentistry because they are relatively inexpensive, user-friendly, long-lasting and generally regarded as safe.

The EPA has recognized concerns over the release of mercury from dental amalgams. According to the EPA, “When mercury in amalgam enters water, certain microorganisms can change it into methylmercury; a highly toxic form of Hg that builds up in fish, shellfish and animals that eat fish. Fish and shellfish are the main sources of methylmercury exposure to humans.” So far, the American Dental Association (ADA) only promotes the voluntary installation of amalgam separators in dental offices. However, the ADA has not implemented recommendations concerning the contamination of aquatic ecosystems by dental amalgam. To date, the ADA has only promoted the voluntary installation of amalgam separators in dental offices. Moreover, there are only ten states in the United States that have mandated mercury removal systems in dental offices, according to the MPP.

Mercury is a concern to human health because it is a persistent bio-accumulative toxin. Many studies have been conducted in an attempt to identify the sources of mercury entering Publicly Owned Treatment Works (POTWs). According to the 2002 Mercury Source Control and Pollution Prevention Program Final Report prepared for the National Association of Clean Water Agencies (NACWA), dental clinics are the main source of mercury discharge to POTWs. It has been estimated that over 50 percent of the mercury entering POTWs can be attributed to dental offices. Moreover, the EPA estimates that dentists discharge approximately 3.7 tons of mercury every year to POTWs. (United States Environmental Protection Agency, http://www.epa.gov/hg/dentalamalgam.html, accessed September, 2011)). The EPA has stated that there are approximately 160,000 dentists working in over 120,000 dental offices that use or remove amalgam in the United States—almost all of which discharge their wastewater exclusively to POTWs. The exact amount of mercury released by each dentist is difficult to determine, but several studies have been conducted over the past ten years and, in general, each dentist in those studies released an average of 56 to 270 mg of mercury per day into the wastewater stream. (Adeqbembo et al., Estimated Quantity of Mercury in Amalgam Waste Water Residue Released by Dentists into the Sewerage System in Ontario, Canada, J. Can. Dent. Assoc. 2004 December; 70(11): 759, 759a-f).

Furthermore, the detection of mercury at a POTW pumping station near the Navy dental treatment facility in Norfolk, Virginia has resulted in the clinic being disconnected from the local wastewater lines of the POTW. (Stone et al., The Management of Mercury in the Dental-Unit Wastewater Stream. Scientific Review of Issues Impacting Dentistry. Vol. 2 No. 1, January 2000. (Navy Dental Corps Electronic Publication). Stone et al., Solid Waste Disposal Issues and Dental Amalgam. Scientific Review of Issues Impacting Dentistry. Vol. 2 No. 2, December 2000. (Navy Dental Corps Electronic Publication). Stone et al., Design and Evaluation of an Integrated System to Remove Mercury from Dental-Unit Wastewater. Journal of Dental Research (2000), Volume 79, Abstract No. 3216). Dental-unit wastewater from the naval clinic has to be collected separately and costs the Navy about $150,000 per year in disposal costs. This pattern of regulatory activity involving violations of local discharge limits has also been reported at the Naval Dental Center, Great Lakes, Ill.; Branch Dental Clinic, Ingleside, Tex.; the Tri-Service Dental Clinic at the Pentagon; Branch Dental Clinic U.S. Navy Yard, Washington, D.C.; and the Arlington Annex, Arlington, Va. Id.

Recently, the EPA has initiated an effluent guideline rulemaking for dental facilities to reduce discharges of mercury to the environment. The EPA expects to propose a rule which may be finalized during late 2012. More importantly, since July 2011, the EPA has been paying more attention to technology assessment of amalgam separators. (United States Environmental Protection Agency. http://www.epa.gov/hg/). This action will not only promote awareness of the dangers of mercury contamination from dental facilities, it will also highlight the need for a more efficient dental amalgam separator.

Numerous studies have shown that the removal of amalgam particulates using currently available filtration systems can only sieve or collect particles larger than 700 μm (microns) in diameter. (Mark Stone and Patty K.-L. Fu, Evaluation of a Commercial Mercury Removal Device, Proceeding, 2006, International Association of Dental Research, No. 40.) But there is a significant amount of mercury located in the dissolved or soluble fraction which is high enough to violate local POTW discharge limits. (Pederson et al., Dental Line Cleanser Effects on Sieved Amalgam Fractions, Journal of Dental Research (2001) Volume 80, Abstract No. 1486.) There is no filtration system currently on the market that has the ability to remove small mercury particles or water soluble mercury. There are few commercially available filters that use extra sorbents in addition to sieving in order to eliminate smaller particulates.

The currently available methods primarily employ physical separation means. There is a need for an efficient filter assembly using both chemical and physical separation means for the removal of mercury from dental waste water and other sources. There is also a need for a filter that can be formed to fit most commercially available dental amalgam filters. Moreover, the filter should be washable for reuse.

### SUMMARY OF THE INVENTION

The present invention relates to a dental amalgam (separator) filter that removes both water soluble and micro-particulate mercury species from dental waste water and other sources. Using highly dispersed tungsten disulfide nanopowder (WS₂NP) within a solid porous support, the absorption and filtration capacity for mercury abatement is substantially increased. In particular, a filter including tungsten disulfide nanopowder according to the present invention is far more efficient (about 93% to 97% removal) than a filter including gold nanoparticles (about 77% removal) in removing water soluble mercury.

According to the present invention, a filter cake can be formed by mixing equal amounts of long fiber cellulose (Sigma-Aldrich Co., St. Louis, Mo.) and instant anchoring cement (Akona Manufacturing, Maple Plain, Minn.) with a tungsten disulfide nanopowder suspension, polyvinyl alcohol and epoxy (Henkel Corporation). The long fiber cellulose is a natural plant fiber available, for example, from Sigma-Aldrich (Catalog No. C6663, CAS No. 9004-34-6). However, any natural viscous staple fiber (Yoon Networks Carbon Fiber Company) or synthetic cellulose fiber (Weyerhaeuser NR Company) can be used. In lieu of Akona instant anchoring cement, DAP Anchor Fast anchoring cement or Quikrete anchoring cement can be used. As the epoxy, Loctite E-05CL Hysol or E-30CL Hysol epoxy adhesive, for example, can be used.

In particular, a tungsten disulfide nanopowder-containing filter cake according to the present invention can be formed as follows:

(i) About 0.75 g polyvinyl alcohol (PVA) is dissolved in about 10 ml of water with continuous stirring under high heat for about 10 min. The mixture is stirred continuously until all of the PVA dissolves to form a clear solution.

(ii) About 1 g tungsten disulfide nanopowder is suspended in about 5 ml of water with continuous stirring for about 10 min. to form a tungsten nanopowder solution.

(iii) About 10 g cellulose (Sigma-Aldrich Co., St. Louis Mo.) and about 10 g instant anchoring cement (Akona Manufacturing, Maple Plain, Minn.) are mixed well in a beaker to form a uniform mixture. To this mixture the tungsten nanopowder solution is added and mixed well. The PVA solution is added and mixed well to form a uniform paste with the addition of water.

(iv) A small quantity of epoxy (Henkel Corporation) is added to the paste and mixed well. This mixture is transferred to a mold and is allowed to dry at room temperature for 12-24 hrs.

(v) After drying, the resulting PVA film is removed carefully.

To evaluate the efficiency of the filter for removing water soluble mercury, about 0.2 g of mercuric nitrate is dissolved in 1000 ml of water (yielding a concentration of about 200 ppm) to simulate mercury-contaminated water. Glass wool is carefully placed above and below the filter. The mercury-containing water is allowed to pass through the filter drop wise. The filtered water is analyzed to determine the efficiency of mercury removal. The results demonstrate about 93-97% removal of water soluble mercury using a tungsten disulfide nanopowder-containing filter according to the present invention, compared to only about 77% removal of water soluble mercury using a gold nanoparticle-containing filter.

In an alternative embodiment, hydroxyapatite (HA), cellulose, a tungsten disulfide nanopowder suspension and a preferably nonionic copolymer are formulated, molded and baked into a filter cake that serves as a solid porous support. In one embodiment, the copolymer can comprise polyoxyethylene and polyoxyproplene, and is preferably a poloxamer derivative.

Poloxamers are nonionic triblock copolymers that include a central hydrophobic polyoxypropylene chain positioned between a pair of hydrophilic polyoxyethylene chains. In view of their amphiphilic structure, poloxamers have surfactant properties useful in increasing the water solubility of hydrophobic, oily substances or otherwise increasing the miscibility of two substances with different hydrophobicities.

In particular, copolymers useful in the practice of the present invention preferably include Poloxamer 407, Poloxamer 338, Poloxamer 237, Poloxamer 188 and Poloxamer 124; polysorbates including Polysorbate 20, Polysorbate 40, Polysorbate 60 and Polysorbate 80; polyethylene glycols including PEG 200, PEG 300 and PEG 400; polyoxyethylene ethers; poly (lactic-co-glycolic acids); and derivatives, mixtures and blends thereof.

In a preferred embodiment, colloidal silver nanoparticles (AgNP) are synthesized and mixed with the cellulose paste before drying or the hydroxyapatite matrix composite before baking. Silver nanoparticles are known for their anti-bacterial and anti-fungal properties. Since dental waste water includes a variety of microorganisms, incorporating AgNP into the filter cake can extend the useful life of the filter.

A further filter cake embodiment includes a 5:1 ratio of non-woven nylon/polyester fibers (3M Corporation) and polyvinyl alcohol (PVA) that has been twined and twirled. Suitable non-woven nylon/polyester fibers available from 3M Corporation include Product Nos. MMM8242 and MMM2020CC.

Depending on the use application and the desired separation/recovery efficiency of the filter assembly, combinations of two or more solid porous supports as described herein can be used, preferably separated by packing material including glass wool fibers, in a single filter assembly.

The WS₂NP can also be incorporated into a polycaprolactone polymeric matrix composite. This procedure involves formation of a crosslinking film to provide a high performance coating film based on the reacting polymer precursors to build up a 3-dimensionally cross-linked network. A mixture of polycaprolactone, nitrocellulose and WS₂NP in acetone, preferably with linseed oil and rosin, is coated onto and within the hydroxyapatite filter cake. Hydroxyapatite (HA) has a high surface area which provides a substantial amount of attachment area for the nanoparticles. The WS₂NP -coated HA filter cake is molded into a filter insert which can be adapted to fit within an existing amalgam filter or a filter assembly as described herein. This insert allows the amalgam filter to capture both water soluble and micro-particulate mercury species from dental waste water. In addition, the filter cake is recyclable. By washing a mercury-filled filter cake with a solution containing a chelating ligand including mercaptopropionic acid or 2,6-pyridinedicarboxylic acid, Hg can be eluted from the WS₂NP within the filter cake.

The present dental amalgam (separator) filter assembly is thus capable of removing both water soluble and micro-particulate mercury species from dental waste water. The use of highly dispersed tungsten disulfide nanopowder (WS₂) as a constituent of the porous solid support dramatically increases the absorption and filtration capacity of the assembly for mercury abatement. According to the present invention, tungsten nanopowder is far more efficient (93% to 97% removal) than gold nanoparticles (77% removal) in removing water soluble Hg.

There are numerous advantages to the present invention. As described herein, an amalgam filter is provided that is capable of removing both water soluble and micro-particulate mercury species from dental waste water and other sources. The filter can be formed to fit most existing amalgam separators. Thus, there is no need to redesign a new separator assembly. In addition, the filter cake is recyclable, allowing the cost of use to be significantly reduced.

### BRIEF DESCRIPTION OF THE DRAWINGS

FIG. 1 shows the formation of a three-dimensional polymer network including tungsten disulfide nanopowder (WS₂NP) in a porous hydroxyapatite (HA) matrix;

FIG. 2 is a sectional view of a filter assembly according to the present invention;

FIG. 3 is a cut-away perspective view of the filter assembly of FIG. 2;

FIG. 4 is a transmission electron microscopy (TEM) image of nanoparticles, as described herein; and

FIG. 5 is a scanning electron microscopy (SEM) image of a solid porous support or filter cake. The image on the left shows the top of the filter cake and the image on the right is a cross-sectional view of the filter cake with a pore size of less than 65 μm (microns) which allows the filter cake to collect and retain micro-particulate mercury. Both images show a high surface area and the three-dimensional network of a filter cake.

### DETAILED DESCRIPTION OF THE INVENTION

A filter cake of the present invention can be incorporated into existing dental amalgam separators (and other sources of water soluble and small particulate mercury) in order to remove water soluble and micro-particulate mercury.

In particular, the present invention includes an article for removing water soluble and micro-particulate mercury from a fluid, the article comprising a solid porous support coated with tungsten disulfide nanopowder (WS₂NP) to form a coated porous support whereby, upon contacting the fluid with the coated porous support, the WS₂NP adsorbs mercury from the fluid. The solid porous support can include hydroxyapatite, cellulose and a copolymer comprising polyoxyethylene and polyoxypropylene including derivatives and blends thereof. The solid porous support can also include colloidal silver nanoparticles to provide anti-bacterial and anti-fungal properties to the solid porous support. The solid porous support is coated with a composition comprising a polycaprolactone and WS₂NP. The composition can include a binding agent selected from the group consisting of linseed oil, tung oil and boiled linseed oil. Moreover, the composition can include an adhesion promoter selected from the group consisting of polyethylene glycol, gum rosin and rosin ester. In an alternative embodiment, titanium ethylacetoacetate or methyltrimethoxysilane can be used as binding agents/adhesion promoters.

The present invention also relates to a method for removing water soluble and micro-particulate mercury from a fluid, comprising the steps of providing a solid porous support coated with WS₂NP to form a coated porous support as described above; and contacting the fluid with the coated porous support whereby the WS₂NP adsorbs mercury from the fluid. The method can also include the step of contacting the coated porous support with a wash solution including mercaptopropionic acid or 2,6-pyridinedicarboxylic acid and derivatives thereof to elute mercury from the coated porous support.

In a preferred embodiment, the present invention relates to a dental amalgam filter for removing mercury from a fluid comprising a porous solid support including hydroxyapatite, cellulose and a copolymer comprising polyoxyethylene and polyoxypropylene and blends thereof admixed with colloidal silver nanoparticles, the porous solid support being coated with a composition comprising a polycaprolactone, WS₂NP, a binding agent and an adhesion promoter to form a coated porous support whereby, upon contacting the fluid with the coated porous support, the WS₂NP adsorbs mercury from the fluid. The binding agent can be selected from the group consisting of linseed oil, tung oil and boiled linseed oil, and the adhesion promoter is selected from the group consisting of polyethylene glycol, gum rosin and rosin ester. The removed mercury includes water soluble and micro-particulate species.

In a corresponding manner, a preferred method according to the present invention includes removing mercury from a fluid comprising providing a porous solid support including hydroxyapatite, cellulose and a copolymer comprising polyoxyethylene and polyoxypropylene including derivatives and blends thereof admixed with colloidal silver nanoparticles; coating the porous solid support with a composition comprising a polycaprolactone, WS₂NP, a binding agent and an adhesion promoter to form a coated porous support; and contacting the fluid with the coated porous support whereby the WS₂NP adsorbs the mercury. The preferred method can also include the step of contacting the coated porous support with a wash solution including mercaptopropionic acid or 2,6-pyridinedicarboxylic acid and derivatives thereof to elute mercury from the coated porous support. The method removes water soluble and micro-particulate mercury species from waste water including dental effluent.

The present invention improves the effectiveness of available technologies that are used in current commercial systems. The present methods are specifically designed for the separation and removal of mercury from waste water, and are suitable for use in most existing dental filters.

### Materials and Methods

### Preparation of Tungsten Disulfide Nanopowder-containing Filter Cake

A tungsten disulfide nanopowder-containing filter cake according to the present invention can be formed as follows:

(i) About 0.75 g polyvinyl alcohol (PVA) is dissolved in about 10 ml of water with continuous stirring under high heat for about 10 min. The mixture is stirred continuously until all of the PVA dissolves to form a clear solution.

(ii) About 1 g tungsten disulfide nanopowder (American Elements, Los Angeles, Calif.) is suspended in about 5 ml of water with continuous stirring for about 10 min. to form a tungsten nanopowder solution.

(iii) About 10 g cellulose (Sigma-Aldrich Co., St. Louis Mo.) and about 10 g instant anchoring cement (Akona Manufacturing, Maple Plain, Minn.) are mixed well in a beaker to form a uniform mixture. To this mixture the tungsten nanopowder solution is added and mixed well. The PVA solution is added and mixed well to form a uniform paste with the addition of water.

(iv) A small quantity of epoxy (Henkel Corporation) is added to the paste and mixed well. This mixture is transferred to a mold and is allowed to dry at room temperature for 12-24 hrs.

(v) After drying, the resulting PVA film is removed carefully.

To evaluate the efficiency of the filter for removing water soluble mercury, about 0.2 g of mercuric nitrate is dissolved in 1000 ml of water (yielding a concentration of about 200 ppm) to simulate mercury-contaminated water. Glass wool is carefully placed above and below the filter. The mercury-containing water is allowed to pass through the filter drop wise. The filtered water is analyzed to determine the efficiency of mercury removal. The results demonstrate about 93-97% removal of water soluble mercury using a tungsten disulfide nanopowder-containing filter according to the present invention, compared to only about 77% removal of water soluble mercury using a gold nanoparticle-containing filter.

Preparation of the Gold Nanoparticles

For comparison purposes, gold nanoparticles (AuNP) are synthesized according to the procedure described by Di Pasqua et al., Preparation of Antibody-conjugated Gold Nanoparticles, 2009, Materials Letters, 63, 1876-1879 generally using the method reported by Laaksonen et al., Stability and electrostatics of mercaptoundecanoic acid-capped gold nanoparticles with varying counterion size, Chem. Phys. Chem., 2006; 7:2143-9, which are incorporated herein by reference.

In particular, AuNP functionalized with 11-mercapto-1-undecanol and 16-mercaptohexadecanoic acid, are synthesized using a method reported by Laaksonen et al. with slight modification. To a solution containing HAuCl₄.3H₂O (about 410 mg) in water (about 6 ml) is added about 200 ml of an ethanol solution containing about 2.7 mmol 11-mercapto-1-undecanol and about 0.3 mmol 16-mercaptohexadecanoic acid. After cooling the solution to about 0° C., about 20 ml of a freshly prepared aqueous solution containing about 380 mg of NaBH₄ is added dropwise with vigorous stirring. The resulting dark brown solution containing alkanethiol-capped Au nanoparticles with pendant alcohol and carboxylic acid functional groups is stirred for about 3 hours after which time the material is allowed to precipitate to the bottom of the flask. The particles are washed twice by dispersing them in about 100 ml of 80% ethanol followed by centrifugation and decantation, and the material is finally washed with about 100 ml of ethanol containing about 50 μL of 1 M HCl solution. The washed material, as the carboxylic acid, is dried under vacuum for about 10 hours. The TEM of the material can be obtained, for example, with a FEI Tecnai T-12S/TEM operating at 120 KeV, and the FT-IR spectrum can be obtained on a Nicolet IR200 FT-IR spectrometer.

Using an alternative method for synthesizing gold nanoparticles, 4 nm gold nanoparticles functionalized with 11-mercapto-1-undecanol and 16-mercaptohexadecanoic acid can also be formed. Asefa et al., Stability and Electrostatics of Mercapto Undecanoic Acid-Capped Gold Nanoparticles with Varying Counterion Size, Chem. Phys. Chem., 2006, 7:2143-9.

Hydrogen tetrachloroaurate (III) hydrate is obtained from Strem Chemicals. The 11-mercapto-1-undecanol and 16-mercaptohexadecanoic acid, N-hydroxysuccinimide (98%), 1-ethyl-3-(3-dimethlaminopropyl)carbodiimide hydrochloride (EDC) and phosphate buffered saline (PBS) are available from Sigma-Aldrich (St. Louis, Mo.). Anhydrous toluene and isopropanol can be obtained from Pharmco-AAPER. Anhydrous acetone is available purchased from Fisher Scientific.

Preparation of the Silver Nanoparticles

AgNP are synthesized according to the procedure described by Shaherdi et al., Synthesis and Effect of Silver Nanoparticles on the Antibacterial Activity of Different Antibiotics against E. coli and S. aureus, 2007, Nanomedicine: Nanotechnology, Biology, and Medicine, 3, 168-171, which is incorporated herein by reference.

In particular, a colloidal AgNP solution is prepared following the method described by Minaian S., The synthesis of silver nanoparticles by Klebsiella pneumonia. Master of Science Thesis, Azasd University of Iran, 10 Sep. 2006; and Minaian et al., Rapid extracellular biosynthesis of silver nanoparticles using Klebsiella pneumonia. Presented at the 56^{th} annual meeting of the Canadian Society of Microbiologists, 18-21 June, London, Ontario, Canada, 2006, also incorporated by reference. Müller-Hinton medium is prepared, sterilized and inoculated with a fresh growth of test strain. The cultured flasks are incubated at about 37° C. for about 24 hours. After the incubation time, the culture is centrifuged at 12,000 rpm and the supernatant is used for the synthesis of AgNP. K. pneumonia culture supernatant is separately added to the reaction vessels containing silver nitrate at a concentration of 10⁻³ M (1% v/v). The reaction between this supernatant and Ag⁺ ions is carried out in bright conditions for about 5 minutes. The bioreduction of the Ag⁺ ions in the solution is monitored by sampling the aqueous component (2 ml) and measuring the ultraviolet-visible (UV-vis) spectrum of the solution. UV-vis spectra of these samples are monitored on a Cecil model 9200 UV-vis spectrophotometer, operated at a resolution of 1 nm. Furthermore, the AgNP can be characterized by transmission electron microscopy (Model EM 208 Philips, Eindhoven, The Netherlands) and energy-dispersive spectroscopy.

In the alternative, AgNP can be formed according to the procedure described by Sondi et al., Preparation of Highly Concentrated Stable Dispersions of Uniform Silver Nanoparticles, J. Colloid. Interface Sci., 260 (2003) 75, which is incorporated by reference.

To 83.3 ml of an aqueous silver nitrate solution, containing 5 wt % Daxad 19 (Hampshire Chemicals) was added 16.7 ml of a 1.5 molar ascorbic acid solution at a controlled flow rate of 2.5 ml per minute. The initial pH can be lowered by perchloric acid, which is added in the silver nitrate solution.

After completion of the precipitation process, the silver precipitates are washed with deionized water to near neutral pH, and redispersed in water. Alternatively, the nanoparticles can be obtained as a dry powder after the solids are separated by centrifugation, washed with acetone, and subsequently dried in vacuo at low temperature. The dry silver particles can be redispersed in deionized water in an ultrasonic bath to obtain concentrated dispersions.

In a further embodiment, AgNP are precipitated following the procedure described above in Sondi et al. (2003) with slight modifications in order to obtain smaller particles with higher specific surface area and narrower size distribution. See Sondi et al., Silver Nanoparticles as Antimicrobial Agent: A Case Study on E. Coli as a Model for Gram-negative Bacteria, J. Colloid. Interface Sci., 275 (2004) 177-182, which is incorporated by reference.

The silver hydrosols are prepared by adding, under agitation, 10 ml of an aqueous 1 molar ascorbic acid solution at a flow rate of 3 ml per minute into 90 ml of an aqueous solution containing 5 wt % of Daxad 19 and 0.33 molar AgNO₃. The reacting solutions are agitated with stirring at 900 rpm at room temperature.

To remove the surfactant and excess silver ions, the resulting silver precipitate is washed five times with deionized water. Finally, the nanosize silver is obtained as a dried powder by freeze drying. The obtained powder can be fully redispersed in deionized water by sonication, and thus aqueous dispersions of silver nanoparticles at the desired concentration can be readily made.

Preparation of the Solid Porous Support

In an alternative embodiment, a filter cake is formed by mixing 40% (w/w) hydroxyapatite (HA) (about 100 g per cake) and 56% (w/w) cellulose (about 140 g per cake) in 100 ml acetone (per cake) with constant stirring. After the components are well mixed, a small amount of acetone and 4% (w/w) poloxamer (about 10 g per cake) are added at the same time until all three composite materials are adequately blended. All steps are performed under low heat with constant stirring. Silver nanoparticles (AgNP) are added with stirring for about 20 minutes or until a uniform paste is formed. The paste is transferred into a mold and is allowed to dry at room temperature for about 24 hours. The filter cake is then placed under a pressing device and pressure of about 100 psi is applied. The pressed filter cake is then baked at about 67° C. for about one hour to form a solid porous support.

In an alternative embodiment, a filter cake can be formed by mixing equal amounts of long fiber cellulose (Sigma-Aldrich Co., St. Louis, Mo.) and instant anchoring cement (Akona Manufacturing, Maple Plain, MN) with about 5 ml of epoxy (Henkel Corporation). The long fiber cellulose is a natural plant fiber available, for example, from Sigma-Aldrich (Catalog No. C6663, CAS No. 9004-34-6). However, any natural viscous staple fiber (Yoon Networks Carbon Fiber Company) or synthetic cellulose fiber (Weyerhaeuser NR Company) can be used. In lieu of Akona instant anchoring cement, DAP Anchor Fast anchoring cement or Quikrete anchoring cement can be used. As the epoxy, Loctite E-05CL Hysol or E-30CL Hysol epoxy adhesive, for example, can be used.

A further filter cake embodiment includes a 5:1 ratio of non-woven nylon/polyester fibers (3M Corporation) and polyvinyl alcohol (PVA) that has been twined and twirled. Suitable non-woven nylon/polyester fibers available from 3M Corporation include Product Nos. MMM8242 and MMM2020CC.

Depending on the use application and the desired separation/recovery efficiency of the filter assembly, combinations of two or more solid porous supports as described herein can be used, preferably separated by packing material including glass wool fibers, in a single filter assembly.

Preparation of the WS₂NP-Containing Coating Material

Nitrocellulose (40 ml), 40 ml acetone and 40 ml polycaprolactone are mixed well together. Then 0.2 g of rosin, 0.2 g of linseed oil and 1.0 g of WS₂NP are added with constant stirring.

In a second embodiment, the coating material can include PEG (high molecular weight polyethylene glycol, Mr>3350) instead of rosin and linseed oil. The other materials listed herein for preparation of the WS₂NP-containing coating material remain the same.

Polyvinyl alcohol (PVA) can also be used as a coating material. PVA is first dissolved in water under high heat with constant stirring. It is difficult to dissolve PVA in water. Once PVA is dissolved, the aqueous solution becomes very viscous. When an aqueous PVA solution dries, a three-dimensional thin film is formed very similar to that described herein for polycaprolactone and nitrocellulose.

Binding Agents

Different binding agents can be used in the present coating formulations. The binding agents (binders) can secure the tungsten disulfide nanopowder and develop adhesion to the solid porous support surface. The present coating methodology involves a crosslinking film formation—the highest-performance coating films are based on reacting polymer precursors to build up a three-dimensionally crosslinked network. At least the following types of natural binders can be added to the matrix:

Drying oils including linseed (flax seed) oil, tung oil or boiled linseed oil which contain at least 50% unsaturated fatty acid triglycerides are natural products that polymerize into a solid form. When reacted with oxygen in the air, these oils crosslink to form network polymers. Adding oxygen to fatty acids and the subsequent formation of hydroperoxide derivatives of the fatty acids is a very complicated process that happens naturally when the oils are exposed to atmospheric oxygen. Oxidation hardens the drying oil at room temperature. Adding 10 to 30% v/v of boiled linseed oil to the present coating formulations enhances the adhesion of the coating material to the solid support surface and provides for even coating.

Adhesion promoters including high molecular weight polyethylene glycol 3000 or a natural resin such as gum rosin and rosin ester can be added to the coating material to strengthen its adhesive properties. Rosin is a treated resin from which one of its constituents, terpenes have been removed. Rosin is very compatible with linseed oil, therefore both can be used together in the formulation. The darker the rosin, the softer it is. There are many different derivatives of rosin and rosin ester; polymerized rosin is preferred herein for improving the adhesive ability of the coating.

In addition, titanium ethylacetoacetate (DuPont) and methyltrimethoxysilane (Dow Chemicals) can be used as binding agents/adhesion promoters.

Incorporation of Tungsten Disulfide Nanopowder

The WS₂NP-containing coating material prepared above is soaked with the foregoing filter cake for about 2 to 3 hours. The nitrocellulose and acetone evaporate, and WS₂NP is coated onto the filter cake and loaded onto the polyoxyethylene/polyoxypropylene copolymer.

Polycaprolactone (PCL) is dissolved in acetone, and the polyethylene glycol (PEG) and the WS₂NP are added. The filter cake is shaken for about 2 hours. The acetone is evaporated and PCL, PEG and WS₂NP are coated onto the filter cake.

Incorporation of Silver Nanoparticles

Silver nanoparticles are incorporated into the filter cake to ensure the stability and durability of the filter. Silver nanoparticles are well known for anti-bacterial and anti-fungal capability. (Shahverdi et al., Synthesis and Effect of Silver Nanoparticles on the Antibacterial Activity of Different Antibiotics against E. coli and S. aureus, 2007, Nanomedicine: Nanotechnology, Biology, and Medicine, 3, 168-171.) (Sondi et al., Silver Nanoparticles as Antimicrobial Agent: A Case Study on E. coli as a Model for Gram-negative Bacteria, J. Colloid Interface Sci., 2004, 275, 177-182.)

Preparation of Dental Amalgam Filter

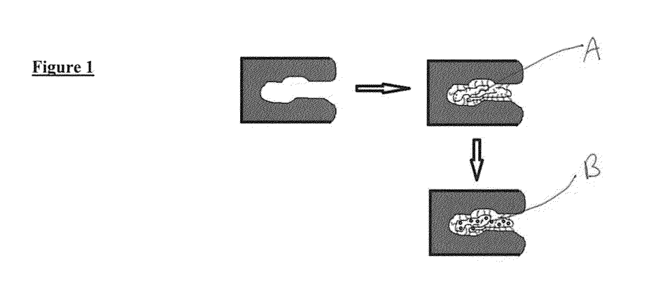

A filter prototype is formed to demonstrate the ability of the present invention to water-soluble and micro-particulate mercury. As shown in FIG. 1, hydroxyapatite pore A receives a polymer B that forms a three-dimensional network whereby WS₂NP are loaded onto the polymer network.

A filter prototype was constructed to test the efficiency of removing water soluble mercury. Both filter cake and nylon/polyester mesh were used to ensure the effectiveness.

### Formation of Filter Cake

About 1.5 of polyvinyl alcohol (PVA) is dissolved in about 40 ml of water and heated on a hot plate under high heat with continuous stirring for about 20 min. until all the PVA dissolves or the solution becomes colorless. About 0.3 g of WS₂NP are dissolved in about 15 ml water and stirred continuously for about 20 min. or until all of the nanopowder is in a suspended state. About 20 g of cellulose and about 20 g of cement are mixed well in a beaker. WS₂NP and a PVA solution are added to the mixture with constant stirring until all of the contents are mixed properly to form a uniform paste. To this paste a small amount of epoxy is added and then the paste is transferred to a mold and left for about 24 hours to dry.

### Nylon/Polyester-PVA Mesh

About 1 g of PVA is dissolved in about 25 ml of water and is heated on a hot plate under high heat with continuous stirring for about 20 min. or until all the PVA dissolves and the solution becomes colorless. About 0.2 g of WS₂NP is suspended in water and stirred continuously for about 20 min. The nanopowder is added to the PVA solution and stirred continuously to form a uniform solution. The resulting solution is added drop by drop on the mesh using a pipette and is left to dry for about 24 hours. About 0.2 g of WS₂NP is suspended in about 10 ml of 95% ethanol and stirred continuously for 15 min. About 0.5 g of rosin is dissolved in 25 ml of boiled linseed oil with continuous stirring under low heat. WS₂NP dissolved in ethanol is added dropwise to the linseed oil and rosin mixture with continuous stirring to form a uniform solution. This solution is added dropwise on the mesh using a pipette. The mesh is left to dry for 24 hours.

### Tungsten Disulfide Nanopowder (WS₂NP) Filter Assembly

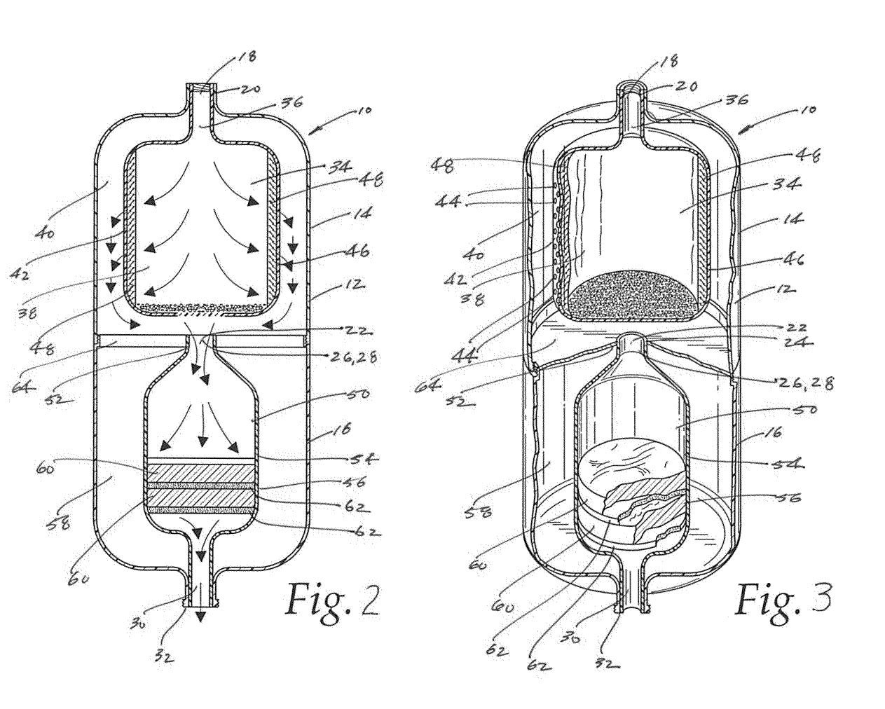

According to a preferred embodiment as shown in FIGS. 2 and 3, the filter assembly 10 according to the present invention comprises a housing 12 including a first portion 14 removably connected to a second portion 16 by a threaded interconnection, snap-fit engagement or the like. The housing 12 and various other components described herein are shown as being substantially circular in cross-section and axially elongated, but other configurations can be employed as is well known to those skilled in the art.

The first portion 14 defines a first opening 18 at an inlet end 20 and a second opening 22 at an outlet end 24. In a similar manner, the second portion 16 defines a first opening 26 at an inlet end 28 and a second opening 30 at an outlet end 32. A threaded nipple adapter (not shown) can be provided at the inlet end 20 of the first portion 14 and at the outlet end 32 of the second portion 16 to provide for easy connectability to a conventional dental amalgam filter/separator via flexible tubing connections.

A first inner chamber 34 positioned within the first portion 14 includes an elongated portion 36 that sealingly, but removably, engages the inlet end 20 of the first portion 14 to define a particulate collecting receptacle 30 within the first portion 14 and a void space 40. The first inner chamber 34 is substantially circular in cross-section and includes a side wall 42 defining a plurality of perforations 44, the inner surface 46 of the side wall 42 being lined with a mesh sieve 48 of metal fiberglass that retains particles larger, for example, than about 0.037-0.044 mm.

A second inner chamber 50 positioned within the second portion 16 includes a collar portion 52 that sealingly, but removably, engages the outlet end 24 of the first portion 14 to define a filtration cartridge 54 including a plurality of layered filtration members 56 and a void space 58. The filtration members 56 include alternating layers of a filter cake 60 according to the present invention and glass wool 62. For example, FIG. 3 shows two filter cake layers 60 (each filter cake layer being about 3 inches in diameter and about ⅝ inch thick) and two glass wool layers 62 (each glass wool layer being about ¼ inch thick).

The sealing engagement of the elongated portion 36 of the first inner chamber 34 with the inlet end 20 of the first portion 14 and the sealing engagement of the collar portion 52 of the second inner chamber 50 with the outlet end 32 of the second portion 16 can be a threaded interconnection or the like. Positioned between the first and second portions is a partition member 64 that is sealingly engaged to collar portion 52 and the inner surfaces of the first and second portions to separate the void space 40 of the first portion 14 and the void space 58 of the second portion 16. The filter assembly 10 is constructed to provide for easy disassembly for replacement or washing of components. In particular, the first inner chamber 34 that defines the particulate collecting receptacle 38 and the second inner chamber 50 that defines the filtration cartridge 54 must be removable for replacement or washing, as necessary, to allow for efficient separation of micro-particulate mercury and water-soluble mercury species.

In operation, effluent including water-soluble and micro-particulate mercury species is charged to the inlet end of the first portion 14 and flows through the first inner chamber 34 of the first portion 14. The direction of flow within the filter assembly 10 is shown by arrows. The mesh sieve 48 along the side wall 42 of the first inner chamber 34 collects any particulate matter including micro-particulate mercury species above a predetermined size. The substantially micro-particulate-free effluent then passes through the void space 40 of the first portion 14 and through the outlet end 32 of the first portion 14 into the inlet end 28 of the second portion 16. The plurality of layered filtration members 56 within the second inner chamber 50 of the second portion 16 separates any remaining micro-particulate materials and any water-soluble mercury species before the effluent passes through the outlet end 32 of the second portion 16 of the filter assembly 10. The filter assembly is designed for use in conjunction with commercially available dental amalgam filters/separators.

Analysis of Materials

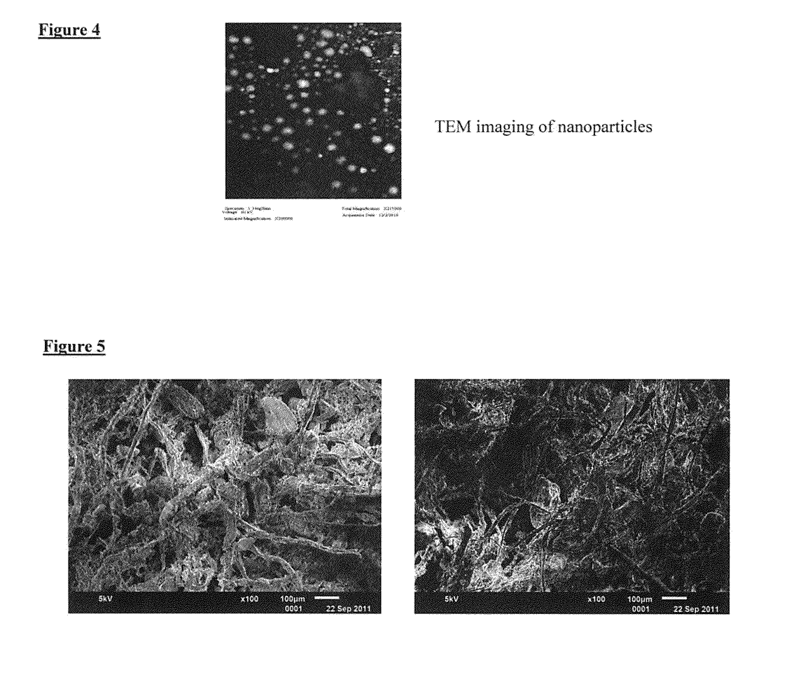

FIG. 4 is a transmission electron microscopy (TEM) image of nanoparticles formed as described herein. The TEM used herein is a JEOL JEM-ARM200CF with a cold field emission source, CEOS probe aberration corrector, Gatan digital cameras, Oxford Energy Dispersive X-ray Spectroscopy (XEDS) and Gatan Electron Energy Loss Spectroscopy (EELS).

SEM-EDX (scanning electron microscopy-elemental analysis) is performed to analyze the coating, as shown in FIG. 5. The SEM used herein is a JEOL JSM-6320F high resolution Field Emission SEM with Thermo Noran XEDS. The sample is mounted onto a carbon tape using a specimen holder and is analyzed using the back scatter method. The SEM of the top of the sample and a cross section is collected.

The SEM image on the left in FIG. 5 shows the top of the filter cake (solid porous support) and the image on the right is a cross-sectional view. Both images show a high surface area and the three-dimensional network of a filter cake. A representative filter cake, as described herein, has a pore size of less than 65 μm (microns) which allows the filter cake to retain micro-particulate mercury. Water soluble mercury is quantitated by cold vapor atomic fluorescent spectrometry and cold vapor ICP-MS to ensure the efficiency of the Hg removal.

An elemental analysis of the filter cake is conducted using X-Ray Fluorescence Spectroscopy. Spectra are collected at 50 kV and 1,000 uA. An 80 mil collimator with a molybdenum filter is used to maximize the signal from the sample and minimize the background from the excitation source. The spectra confirm the presence of nanoparticles and their uniform distribution throughout the filter cake.

Regeneration of Filter

After the filter cake (solid porous support) reaches its capacity of mercury loading (indicated by a decreases in the flow rate/output volume of waste water), it is removed from the filter and washed. Washing the Hg-loaded filter cake with mercaptopropionic acid and 2,6-pyridinedicarboxylic acid (dipicolinic acid) and derivatives thereof elutes Hg from the AuNP. Mercaptopropionic acid and 2,6-pyridinedicarboxylic acid are chelating ligands which are known to have high affinities towards mercury with binding constants of log K 10.1 and 20.2, respectively. (Darbha et al., Gold Nanoparticles-based Miniaturized Nanomaterial Surface Energy Transfer Prob for Rapid and Ultrasensitive Detection of Mercury in Soil, Water, and Fish, ACS Nano, 2007, 1, 36, 208-214.)

The present invention relies on chemical reactions and specific targeting, which makes it distinct from currently available amalgam separators and mercury filters which depend on physical separation processes (sieving).

The WS₂NP-coated solid porous support according to the present invention is more efficient than conventional dental amalgam separators in terms of collecting mercury. It is estimated that about 250-300 mg of mercury is released per day from a typical dental office which equals about 45-54 g about every six months. About 90 percent (about 40-49 g) of solid particulate mercury can be collected using physical means (i.e., sieving). The WS₂NP-coated solid porous support of the present invention can collect about 6 g of water soluble mercury in addition to the above quantities of solid particulate mercury which makes the present approach, as described above, about 97 percent efficient.

Recovery

In a first trial, the concentration of water soluble mercury (II) prior to passage through and treatment by a tungsten disulfide nanopowder filter was 103 mg/L. The concentration of water soluble mercury (II) after passage through and treatment by the WS₂NP filter was 2.7 mg/L. This represents a recovery of about 97.4 percent water soluble mercury.

In a second trial, the concentration of water soluble mercury (II) prior to and after passage through and treatment by a WS₂NP filter according to the present invention was 103 mg/L and 7.7 mg/L, respectively. This represents a recovery of about 92.5 percent water soluble mercury.

On the other hand, the concentration of water soluble mercury (II) prior to and after passage through and treatment by a gold nanoparticle filter, as described herein, was 192 mg/L and 44.5 mg/L, respectively. This represents a recovery of about 76.8 percent water soluble mercury.

### PUBLICATIONS

1. United States Environmental Protection Agency. http://www.epa.gov/hg/dentalamalgam.html (Accessed September, 2011).
2. Adeqbembo, A. Q. and Watson, P. A., Estimated Quantity of Mercury in Amalgam Waste Water Residue Released by Dentists into the Sewerage System in Ontario, Canada, J. Can. Dent. Assoc. 2004 December; 70(11): 759, 759a-f.
3. Stone, M.; Pederson, E.; Kelly, B.; Ragain, J.; Karaway, R.; Auxer, R. and Davis, S., The Management of Mercury in the Dental-Unit Wastewater Stream. Scientific Review of Issues Impacting Dentistry. Vol. 2, No. 1. January 2000. (Navy Dental Corps Electronic Publication).
4. Stone, M.; Pederson, E.; Cohen, M.; Ragain, J.; Jones, G.; Karaway, R.; Simecek, J. and Diefenderfer, K., Solid Waste Disposal Issues and Dental Amalgam. Scientific Review of Issues Impacting Dentistry. Vol. 2, No. 2. December 2000. (Navy Dental Corps Electronic Publication).
5. Stone, M.; Pederson, E.; Karaway, R.; Auxer, R. and Davis, S., Design and Evaluation of an Integrated System to Remove Mercury from Dental-Unit Wastewater. Journal of Dental Research (2000), Volume 79, Abstract No. 3216.
6. United States Environmental Protection Agency. http://www.epa.gov/hg/.
7. Stone, M. and Patty K.-L. Fu, Evaluation of a Commercial Mercury Removal Device. Proceeding, 2006, International Association of Dental Research, No. 40.
8. Pederson, E.; Stone, M.; Ragain, J.; Auxer, R. and Karaway, R., Dental Line Cleanser Effects on Sieved Amalgam Fractions. Journal of Dental Research (2001) Volume 80, Abstract No. 1486.
9. Di Pasqua, A. J.; Mishler, R. E.; Ship, Y.-L.; Dabrowiak, J. C. and Asefa, T., Preparation of Antibody-conjugated Gold Nanoparticles, 2009, Materials Letters, 63, 1876-1879.
10. Shaherdi, A. R.; Fakhimi, A.; Shahverdi, H. R. and Minaian, S., Synthesis and Effect of Silver Nanoparticles on the Antibacterial Activity of Different Antibiotics Against E. coli and S. aureus, 2007, Nanomedicine: Nanotechnology, Biology and Medicine, 3, 168-171.
11. Sondi, I. and Salopek-Sondi, B., Silver Nanoparticles as Antimicrobial Agent: A Case Study on E. coli as a Model for Gram-negative Bacteria, J. Colloid Interface Sci., 2004, 275, 177-182.
12. Darbha, G. K.; Ray, A. and Ray, P. C., Gold Nanoparticles-based Miniaturized Nanomaterial Surface Energy Transfer Prob for Rapid and Ultrasensitive Detection of Mercury in Soil, Water and Fish, ACS Nano, 2007, 1, 36, 208-214.

Although the present invention has been described with respect to particular nanoparticles, porous supports, formulations and methods, it will be apparent that a variety of modifications and changes can be made without departing from the scope and spirit of the invention, as described and claimed herein.

What is claimed is:

1. An article for removing water soluble and micro-particulate mercury from a fluid comprising a solid porous support coated with tungsten-containing nanopowder to form a coated porous support whereby, upon contacting the fluid with the coated porous support, the tungsten-containing nanopowder adsorb mercury from the fluid.

2. The article according to claim 1 wherein the solid porous support includes hydroxyapatite, cellulose and a copolymer comprising polyoxyethylene and polyoxypropylene including derivatives and blends thereof.

3. The article according to claim 1 wherein the solid porous support includes long fiber cellulose, anchoring cement and epoxy.

4. The article according to claim 1 wherein the solid porous support includes non-woven nylon/polyester fibers and polyvinyl alcohol.

5. The article according to claim 1 wherein the solid porous support includes colloidal silver nanopowder to provide anti-bacterial and anti-fungal properties to the solid porous support.

6. The article according to claim 1 wherein the solid porous support is coated with a composition comprising a polycaprolactone and tungsten-containing nanopowder.

7. The article according to claim 1 wherein the solid porous support is coated with a composition comprising a polyvinyl alcohol and tungsten-containing nanopowder.

8. The article according to claim 1 wherein the composition includes a binding agent selected from the group consisting of linseed oil, tung oil and boiled linseed oil.

9. The article according to claim 1 wherein the composition includes an adhesion promoter selected from the group consisting of polyethylene glycol, gum rosin and rosin ester.

10. The article according to claim 1 wherein the binding agent or adhesion promoter is titanium ethylacetoacetate or methyltrimethoxysilane.

11. A method for removing water soluble and micro-particulate mercury from a fluid, comprising the steps of providing a solid porous support coated with tungsten-containing nanopowder to form a coated porous support; and contacting the fluid with the coated porous support whereby the tungsten-containing nanopowder adsorb mercury from the fluid.

12. A method according to claim 11 further including the step of contacting the coated porous support with a wash solution including mercaptopropionic acid or 2,6-pyridinedicarboxylic acid and derivatives thereof to elute mercury from the coated porous support.

13. The method according to claim 11 wherein the solid porous support includes hydroxyapatite, cellulose and a copolymer comprising polyoxyethylene and polyoxypropylene including derivatives and blends thereof.

14. The method according to claim 11 wherein the solid porous support includes long fiber cellulose, anchoring cement and epoxy.

15. The method according to claim 11 wherein the solid porous support includes non-woven nylon/polyester fibers and polyvinyl alcohol.

16. The method according to claim 11 wherein the solid porous support includes colloidal silver nanopowder to provide anti-bacterial and anti-fungal properties to the solid porous support.

17. The method according to claim 11 wherein the solid porous support is coated with a composition comprising a polycaprolactone and tungsten-containing nanopowder.

18. The method according to claim 11 wherein the solid porous support is coated with a composition comprising a polyvinyl alcohol and tungsten-containing nanopowder.

19. The method according to claim 11 wherein the composition includes a binding agent selected from the group consisting of linseed oil, tung oil and boiled linseed oil.

20. The method according to claim 11 wherein the composition includes an adhesion promoter selected from the group consisting of polyethylene glycol, gum rosin and rosin ester.

21. The method according to claim 11 wherein the binding agent or adhesion promoter is titanium ethylacetoacetate or methyltrimethoxysilane.

22. A dental amalgam filter for removing mercury from a fluid comprising a porous solid support including hydroxyapatite, cellulose and a copolymer comprising polyoxyethylene and polyoxypropylene and blends thereof admixed with colloidal silver nanopowder, the porous solid support being coated with a composition comprising a polymer selected from the group consisting of a polycaprolactone and a polyvinyl alcohol, tungsten-containing nanopowder, a binding agent and an adhesion promoter to form a coated porous support whereby, upon contacting the fluid with the coated porous support, the tungsten-containing nanopowder adsorb mercury from the fluid.

23. The dental amalgam filter according to claim 22 wherein the binding agent is selected from the group consisting of linseed oil, tung oil and boiled linseed oil.

24. The dental amalgam filter according to claim 22 wherein the adhesion promoter is selected from the group consisting of polyethylene glycol, gum rosin and rosin ester.

25. The dental amalgam filter according to claim 22 wherein the binding agent or adhesion promoter is titanium ethylacetoacetate or methyltrimethoxysilane.

26. The dental amalgam filter according to claim 22 wherein the mercury includes water soluble and micro-particulate species.

27. A method for removing mercury from a fluid comprising:
a) providing a porous solid support including hydroxyapatite, cellulose and a copolymer comprising polyoxyethylene and polyoxypropylene including derivatives and blends thereof admixed with colloidal silver nanopowder;
b) coating the porous solid support with a composition comprising a polymer selected from the group consisting of a polycaprolactone and a polyvinyl alcohol, tungsten-containing nanopowder, a binding agent and an adhesion promoter to form a coated porous support; and
c) contacting the fluid with the coated porous support whereby the tungsten-containing nanopowder adsorb the mercury.

28. A method according to claim 27 further including the step of contacting the coated porous support with a wash solution including mercaptopropionic acid or 2,6-pyridinedicarboxylic acid and derivatives thereof to elute mercury from the coated porous support.

29. The method according to claim 27 wherein the binding agent is selected from the group consisting of linseed oil, tung oil and boiled linseed oil.

30. The method according to claim 27 wherein the adhesion promoter is selected from the group consisting of polyethylene glycol, gum rosin and rosin ester.

31. The method according to claim 27 wherein the binding agent or adhesion promoter is titanium ethylacetoacetate or methyltrimethoxysilane.

32. The method according to claim 27 wherein the mercury includes water soluble and micro-particulate species.
